(19) United States
(12) Patent Application Publication
(10) Pub. No.: US 2003/0156395 A1
(43) Pub. Date: Aug. 21, 2003

(54) Electronic component and method of manufacturing same

(75) Inventor: Kenta Ogawa, Kanagawa (JP)

Correspondence Address: McGinn & Gibb, PLLC, Suite 200, 8321 Old Courthouse Road, Vienna, VA, 22182-3817, US

(73) Assignee: NEC Electronics Corporation, Kawasaki (JP)

(21) Appl. No.: 10/367,699

(22) Filed: Feb. 19, 2003

(30) Foreign Application Priority Data
Feb. 20, 2002 (JP) 2002-042846

(51) Int. Cl. H01R 9/00

(52) U.S. Cl. 361/764

(57) ABSTRACT

An electronic component is provided with a connection conductive layer containing a 0.05 weight percent to 1.5 weight percent of nickel in a Sn—Bi (tin-bismuth) alloy on a surface of a lead used as an external terminal. Nickel (Ni) crystallizes as a deposition phase in a tin-bismuth alloy structure and acts to inhibit component atoms making up the Sn—Bi alloy from migrating along a crystal grain boundary between two tin (Sn) crystal grains being adjacent to each other. Therefore, a secular change of the alloy structure of the Sn—Bi alloy used as the connection conductive layer becomes small.

### BACKGROUND OF THE INVENTION

1. Field of the Invention

The present invention relates to an electronic component (device) and a method of manufacturing the same and, more particularly, relates to the electronic component (device) and the method of manufacturing the same in which a connection conductive layer containing Sn—Bi (tin-bismuth) alloy is formed on an external terminal.

The present application claims priority of Japanese Patent Application No. 2002-042846 filed on Feb. 20, 2002, which is hereby incorporated by reference.

2. Description of Related Art

An electronic apparatus to be used in a wide field is assembled by using various electronic components such as an IC (Integrated Circuit), a transistor, a capacitor, a resistor, an inductor or a like. When the electronic apparatus is assembled, an isolation substrate on which a circuit pattern made of a conductive layer is previously printed (hereinafter, simply referred to as circuit substrate) is used, and desired electronic components are mounted on the circuit substrate. Concretely, a lead serving as an external terminal in an electronic component is soldered and connected electrically to the circuit pattern at a specified place thereof, via a connection conductive layer having a low melting point, as known as solder alloy.

FIG. 8 is a partially sectional view showing a first example for mounting a conventional electronic component. A lead (external terminal) 55 is inserted via a through hole 52 in a circuit substrate 51 and is electrically connected to a circuit pattern 53 formed on a first surface 51A via a connection conductive layer 54 having a low melting point by soldering, whereby an electronic component 56 is mounted. This is called as an insertion-mounted type.

FIG. 9 is a partially sectional view showing a second example for mounting another conventional electronic component. A lead 55 is electrically connected to a circuit pattern 57 formed on a second surface 51B of a circuit substrate 51 via a connection conductive layer 58 having a low melting point by soldering, whereby an electronic component 59 is mounted. This is called as a surface-mounted type.

Also, the first mounting example and the second mounting example are combined, and a double-sided, surface-mounted type is known in which the electronic component 56 is insertion-mounted in the first surface 51A of the circuit substrate 51 and the electronic component 59 is surface-mounted on the second surface 51B of the circuit substrate 51.

The connection conductive layer 54, 58 having the low melting point is previously plated to the lead 55, and is used as a solder in the case of mounting the electronic component 56, 59.

As a material of the above-described connection conductive layer having a low melting point used for soldering, conventionally, Sn—Pb (tin-lead) alloy is widely used. Tin (Sn) functions as adhesion and lead (Pb) lowers the melting point of the Sn—Pb alloy and improves connection reliability. As described, the melting point of the Sn—Pb alloy can be adjusted easily by changing a ratio between the tin (Sn) and the lead (Pb), a cost is low in addition to a good electrical connection, and therefore, the Sn—Pb alloy is used by choice.

However, a Pb-component in the Sn—Pb alloy is harmful to humans bodies. When used electronic components are discarded, these cause pollution, and therefore it is not preferable in view of environmental disruption. Therefore, recently, when an electronic component is mounted on a circuit substrate, a connection conductive layer not containing lead (Pb) in the solder alloy, so-called a Pb-free connection conductive layer, having a low melting point is generally used.

For example, Japanese Patent Application Laid-open No. Hei 11-251503 discloses an electronic component using Sn—Bi (tin-bismuth) alloy in which Bi is substituted instead of Pb as the Pb-free connection conductive layer having a low melting point. Japanese Patent Application Laid-open No. Hei 11-251503 discloses an electronic component in which a metal layer (connection conductive layer) containing less than 4 weight % of bismuth (Bi) in tin (Sn) is formed on an external connection electrode lead wire by a dipping method, a plating method, or a like. The bismuth (Bi) functions similarly to the lead (Pb) in the above-mentioned Sn—Pb alloy and functions to lower the melting point of the Sn—Bi alloy.

Now, in the electronic component in which the conventional Sn—Bi alloy is used as the connection conductive layer, a small amount of Bi is solid-soluble in the tin (Sn) and functions to lower the melting point of the Sn—Bi alloy. However, it is difficult that the Sn—Bi alloy having a low melting point and having no deposition phase is formed into a stable alloy structure. Therefore, there is a problem in that a great secure change in the alloy structure occur.

Hereunder, this reason will be explained. FIG. 10 is a schematic view showing a sectional structure of a part of an electronic component in which the Sn—Bi alloy is plated on a lead as a connection conductive layer. For example, a connection conductive layer 62 made of the Sn—Bi alloy is plated on a surface of a lead 61 made of a Fe—Ni (iron-nickel) alloy. In the Sn—Bi alloy to be the connection conductive layer 62, for example, less than 4 weight % of the Bi is solid-soluble in the tin (Sn) as described in Japanese Patent Application Laid-open No. Hei 11-251503 and functions to lower the melting point of the Sn—Bi alloy. In the alloy structure of the Sn—Bi alloy in which the Bi is solid-soluble in the tin (Sn), a crystal grain boundary 64 is formed between Sn crystals 63 to be main components of the Sn—Bi alloy. Also, when a content of the Bi in the Sn—Bi alloy (for example, less than 4 weight %) increases, it is not preferable since a connection strength of the Sn—Bi alloy becomes weak as described in Japanese Patent Application Laid-open No. Hei 11-251503.

Now, in the Sn—Bi alloy structure having the low melting point, even at room temperature, crystal grains being made up of each kind of component atoms of the alloy (base material) easily generate in accordance with the passage of time, and another kind of alloy layer generates and grows easily at an interface between the Sn—Bi alloy and the plating layer. Also, generally, in a crystal grain boundary between crystals, atom migration (crystal grain boundary diffusion) tends to occur along the crystal grain boundary even at a comparative low temperature. For example, as shown in FIG. 10, a phenomenon occurs in which, in the alloy structure of the Sn—Bi alloy to be the connection conductive layer 62, in the crystal grain boundary 64 between the Sn crystals 63, at a step before mounting the electronic component on the circuit substrate 51 or at a step after mounting the electronic component 56, 59 on the circuit substrate 51, a Sn atom or a Bi atom forming the Sn—Bi alloy tends to migrate easily along the crystal grain boundary 64 in accordance with the passage of time.

As described above, the crystal growth in the plated layer, the formation and the growth of the other alloy layer at the interface between the Sn—Bi alloy and the plating layer, and that the component atoms making up the Sn—Bi alloy tends to migrating along the crystal grain boundary in accordance with the passage of time indicate that the alloy structure of the Sn—Bi alloy becomes unstable and a time passage change (a change in accordance with a passage of time) of the alloy structure of the Sn—Bi alloy becomes large. When the time passage change of the alloy structure becomes large, after mounting the electronic component 56, 59 on the circuit substrate 51, an electronic connectivity, an insulativity, a connection strength, and a like of the electronic component lower, and therefore, the reliability of mounting the electronic component 56, 59 degrades.

On the other hand, in the Sn—Pb alloy conventionally used as the connection conductive layer, the lead (Pb) has a less solid solubility limit to the tin (Sn) than that of the bismuth (B)i to the tin (Sn), and can be added more than the amount of the bismuth (Bi), and therefore, as shown in FIG. 11, the lead (Pb) crystallizes in the crystal grain boundary 64 between the tin (Sn) crystals 63 as a lead (Pb) deposition phase 65. Then, the lead (Pb) deposition phase 65 makes the changing of the crystal grain boundary 64 in accordance with the crystal growth small and makes the migration of the component atoms making up the Sn—Pb alloy along the crystal grain boundary 64 small. Therefore, in the Sn—Pb alloy, the time passage change of the alloy structure is reduced in comparison with that of the Sn—Bi alloy. However, the Sn—Pb alloy cannot be used as the connection conductive layer because of the above-described reasons.

### SUMMARY OF THE INVENTION

In view of the above, it is an object of the present invention to provide an electronic component and a method of manufacturing the electronic component capable of reducing a time passage change of an alloy structure of an Sn—Bi alloy used as a connection conductive layer.

According to a first aspect of the present invention, there is provided an electronic component having an external terminal of which a surface is covered with a connection conductive layer made of a tin-bismuth alloy, wherein the Sn—Bi alloy contains a metal of which a solid solubility limit to tin (Sn) at room temperature is less than that of Bi in the Sn—Bi alloy.

In the foregoing, a preferable mode is one wherein the metal of which the solid solubility limit to the tin (Sn) at the room temperature is less than that of bismuth (Bi), and is a metal of which an ionization tendency is greater than that of the tin (Sn).

Also, a preferable mode is one wherein the metal of which the ionization tendency is greater than that of the tin (Sn) is nickel (Ni) and a 0.05 weight % to 1.5 weight % of the nickel (Ni) is included in the Sn—Bi alloy.

Also, a preferable mode is one wherein the metal of which the ionization tendency is greater than that of the tin (Sn) is zinc (Zn), aluminum (Al) or iron (Fe).

Also, a preferable mode is one wherein the metal of which the solid solubility limit to the tin (Sn) is less than that of Bi is a metal of which an ionization tendency is less than that of the tin (Sn).

Also, a preferable mode is one wherein the metal of which the ionization tendency is less than that of the tin (Sn) is copper (Cu), silver (Ag), palladium (Pd), or gold (Au).

Furthermore, a preferable mode is one wherein the connection conductive layer is formed by an electroplating method.

According to a second aspect of the present invention, there is provided a method of manufacturing an electronic component having an external terminal of which a surface is covered with a connection conductive layer made of a tin-bismuth alloy, the method including:

a step of placing a positive plate and the external terminal respectively in a solution containing tin (Sn) and bismuth (Bi), the positive plate being made of a tin-nickel alloy containing 0.01 weight percent to 3 weight percent of nickel (Ni) and being connected to a positive electrode of a direct current source, and also the external terminal being connected to a negative electrode of the direct current source; and

a step of forming the connection conductive layer made of the nickel-bismuth alloy containing a 0.05 weight percent to 1.5 weight percent of nickel (Ni) on the external terminal by an electroplating method.

According to a third aspect of the present invention, there is provided a method of manufacturing an electronic component having an external terminal of which a surface is covered with a connection conductive layer made of a tin-bismuth alloy, the method including:

a step of placing a positive plate and the external terminal respectively in a solution containing tin (Sn), bismuth (Bi) and nickel (Ni), the positive plate being made of tin and being connected to a positive electrode of a direct current source, and also the external terminal being connected to a negative electrode of the direct current source; and

a step of forming the connection conductive layer made of the nickel-bismuth alloy containing a 0.05 weight percent to 1.5 weight percent of nickel (Ni) on the external terminal by an electroplating method.

According to a fourth aspect of the present invention, there is provided a method of manufacturing an electronic component having an external terminal of which a surface is covered with a connection conductive layer made of a tin-bismuth alloy, the method including:

a step of applying a heat treatment so as to diffuse a specified metal after coating tin (Sn), bismuth (Bi) and the specified metal to the external terminal; and

a step of forming the connection conductive layer made of the tin-bismuth alloy containing a specified amount of the specified metal on the external terminal.

With these configurations, in an electronic component according to the present invention, since a connection conductive layer containing a desired metal of which a solid solubility limit to tin (Sn) is less than that of Bi in the Sn—Bi alloy is formed on an external terminal, the desired metal is crystallized as a deposition phase, and the component atoms making up the Sn—Bi alloy is inhabited from migrating along a crystal grain boundary between the Sn crystals.

Also, with the method of manufacturing the electronic component according to the present invention, by electroplating an external terminal with a positive plate made of Sn—Ni alloy containing a desired metal of which a solid solubility limit to tin (Sn) is less than that of bismuth (Bi), the connection conductive layer containing a suitable amount of the desired metal in the Sn—Bi alloy is formed on the external terminal, and therefore, the connection conductive layer can be formed easily.

Also, with the method of manufacturing the electronic component according to the present invention, by previously adding a desired metal of a solid solubility limit to tin (Sn) is less than that of Bi and by electroplating an external terminal with an Sn—Bi solution, the connection conductive layer containing a suitable amount of the desired metal in the Sn—Bi alloy is formed on the external terminal, and therefore, the connection conductive layer can be formed easily.

Therefore, it is possible to make the time passage change of the alloy structure of the Sn—Bi alloy used as the connection conductive layer small.

### BRIEF DESCRIPTION OF THE DRAWINGS

The above and other objects, advantages, and features of the present invention will be more apparent from the following description taken in conjunction with the accompanying drawings in which:

FIG. 1 is a perspective view showing a structure of an electronic component according to a first embodiment of the present invention;

FIG. 2 is a sectional view of FIG. 1 taken along a line indicated by arrows A and A;

FIG. 3 is a sectional view showing an electronic component being mounted on a circuit substrate according to the first embodiment of the present invention;

FIG. 4 is a schematic view showing a sectional structure of a part of the electronic component according to the first embodiment of the present invention;

FIG. 5 is an illustrated view for explaining a plating method used in a first manufacturing method of the electronic component according to the first embodiment of the present invention;

FIG. 6 is an illustrative view for explaining another plating method used in a second manufacturing method of the electronic component according to the first embodiment of the present invention;

FIG. 7A to FIG. 7E are views showing electronic components according to the present invention;

FIG. 8 is sectional view showing a first conventional example of an electronic component being mounted on a circuit substrate;

FIG. 9 is sectional view showing a second conventional example of an electronic component being mounted on a circuit substrate;

FIG. 10 is a schematic view showing a sectional structure of a portion of a conventional electronic component; and

FIG. 11 is a schematic view showing a sectional structure of a portion of another conventional electronic component.

### DETAILED DESCRIPTION OF THE PREFERRED EMBODIMENTS

Best modes for carrying out the present invention will be described in further detail using embodiments with reference to the accompanying drawings.

First Embodiment

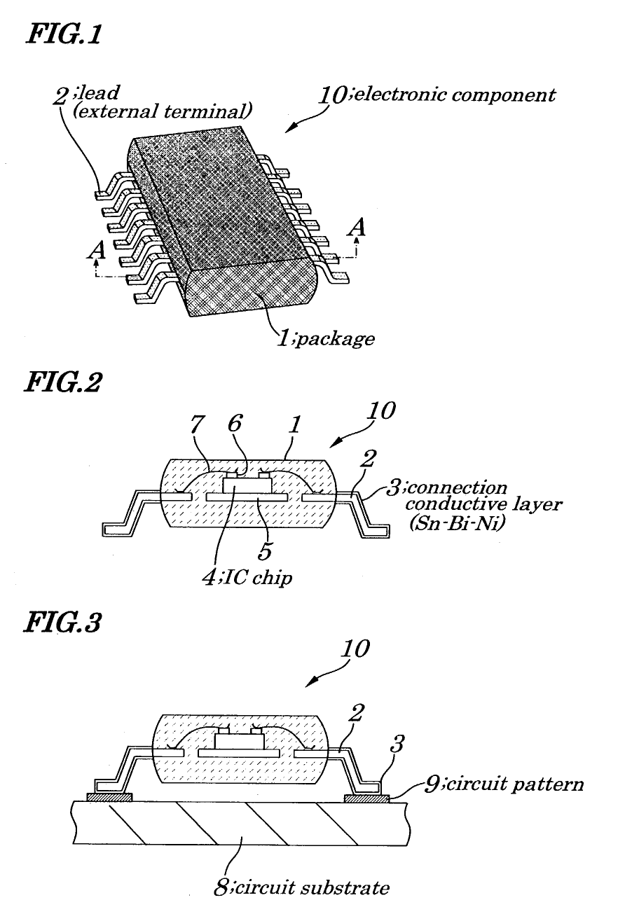

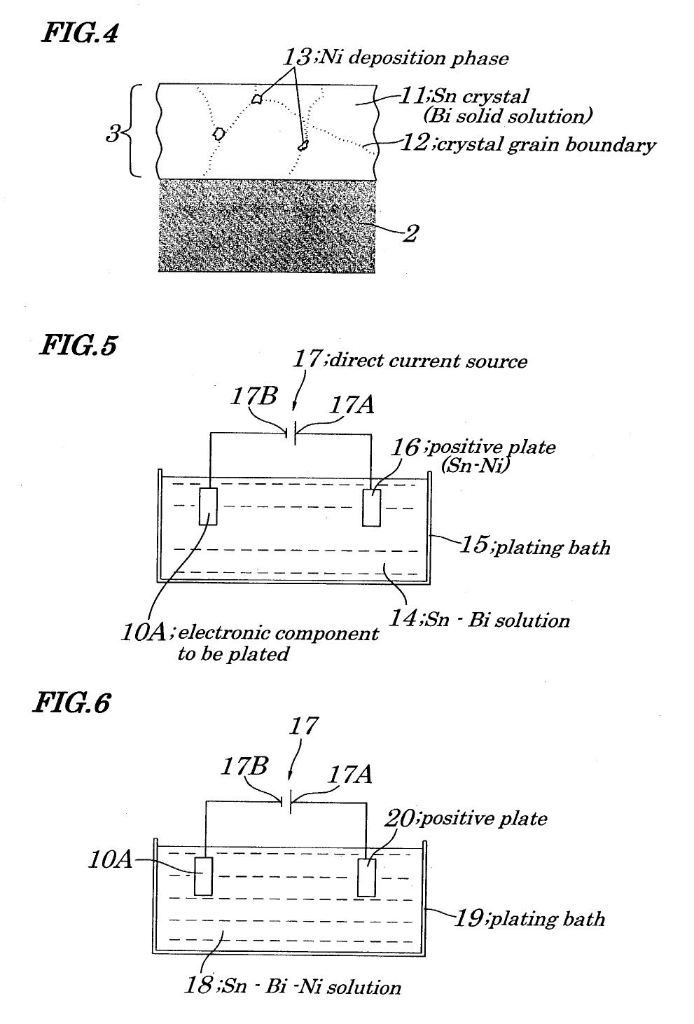

FIG. 1 is a perspective view showing a structure of an electronic component (device) according to a first embodiment of the present invention, FIG. 2 is a sectional view of FIG. 1 taken along a line indicated by arrows A and A, FIG. 3 is a sectional view showing an electronic component being mounted on a circuit substrate according to the first embodiment, FIG. 4 is a schematic view showing a sectional structure of a portion of the electronic component according to the embodiment, FIG. 5 is an illustrated view for explaining a plating method used in a first manufacturing method of the electronic component according to the first embodiment, and FIG. 6 is an illustrative view for explaining another plating method used in a second manufacturing method of the electronic component according to the first embodiment. In the first embodiment, a semiconductor device such as an IC (Integrated Circuit) or a like is used as an example of the electronic component.

An electronic component (device) 10 according to the first embodiment, as shown in FIG. 1 and FIG. 2, is provided with a package 1 formed by resin-molding or a like and a plurality of leads 2 made of Fe—Ni (iron-nickel) alloy, for example, being extended from both sides of the package 1. On a surface each of leads 2 is coated with a connection conductive layer 3 made of the Sn—Bi (tin-bismuth) alloy containing a 0.05 weight % to 1.5 weight % of nickel (Ni), more preferably, approximately 0.5 weight % of nickel (Ni), and as a result having a low melting point. In an inside of the package 1, as shown in FIG. 2, an IC chip 4 is fixed onto a tab 5, and a bonding wire 7 is electrically connected between a pad electrode 6 formed on a surface of the IC chip 4 and the lead 2 corresponding to the pad electrode 6. Here, it is preferable to use the plating method so as to form on the lead 2 the connection conductive layer 3 having the low melting point, and therefore, the above-mentioned nickel (Ni) is selected from this viewpoint. The nickel (Ni) is a metal of which the solid solubility limit to the tin (Sn) is less than that of the bismuth (Bi) at room (ordinary) temperature, and is selected as a metal of which an ionization tendency is greater than that of the tin (Sn) being a main component of the Sn—Bi alloy.

FIG. 3 shows a mounting example of the electronic component 10 according to the first embodiment. The electronic component 10 is surface-mounted on a circuit pattern 9 formed on a surface of a circuit substrate 8 by soldering the lead 2 via the connection conductive layer 3 having the low melting point so as to be electrically connected to the circuit pattern 9.

In the connection conductive layer 3 made of the Sn—Bi alloy containing the nickel (Ni), 1 weight % to 4 weight % of the Bi is contained into the tin (Sn) and an approximate remaining component is the tin (Sn). Then, the connection conductive layer 3 includes a 0.05 weight % to 1.5 weight % of the nickel (Ni) of which the solid solubility limit to the tin (Sn) at the room temperature is less than that of the bismuth (Bi). The bismuth (Bi) is solid-soluble in the tin (Sn), as shown in FIG. 4 of a sectional structure of a part of the electronic component 10, a crystal grain boundary 12 is produced between Sn crystals 11 adjacent to each other as a main component of the alloy. However, since the nickel (Ni) is hardly solid-soluble in the tin (Sn) (a 0.05 weight % to 1.5 weight % of the nickel (Ni) is solid-soluble), a nickel deposition phase 13 crystallizes in the crystal grain boundary 12. Therefore, like the lead (Pb) as described above, the nickel deposition phase 13 functions to inhibit component atoms making up the Sn—Bi alloy from migrating along the crystal grain boundary 12.

In this case, the more a content of the nickel (Ni) is increasing, the more stable an alloy structure of the Sn—Bi alloy can be, and therefore, a secular change of the alloy structure can be made small. Also, the more the content of the nickel (Ni) is increasing, the higher a melting point of the Sn—Bi alloy becomes, and therefore, the Sn—Bi alloy is not preferable as a solder alloy. In other words, in a case where the melting point of the Sn—Bi alloy becomes higher by containing the nickel (Ni), when the electronic component 10 is mounded on a circuit substrate 8, it is necessary to make a mounting temperature higher for this. From this point, it is preferable that an upper limit of the content of the nickel (Ni) is set to approximately 1.5 weight %. In this way, the nickel (Ni) is crystallized as the deposition phase 13 in the crystal grain boundary 12 between the Sn crystals 11 adjacent to each other, not that the nickel (Ni) is solid-soluble in the tin (Sn), and therefore, the secular change of the alloy structure can be made small though the content of the nickel (Ni) in the whole alloy is very small. Also, the lower limit of the content of the nickel (Ni) is set to approximately 0.05 weight % by a restriction of a measurement precision in the content ratio.

As described above, in the electronic component 10 according to the first embodiment, since the lead 2 is provided with the connection conductive layer 3 of the Sn—Bi alloy containing a 0.05 weight % to 1.5 weight % of the nickel (Ni), the alloy structure of the Sn—Bi alloy can be made stable and the time passage change of the alloy structure can be made small while wettability deterioration of the connection conductive layer 3 is minimized. Therefore, since, after mounting the electronic par 10 t on the circuit substrate 8, it is possible to prevent the electrical connectivity, connection strength and a like of the electronic component from deteriorating, there is no case in that the reliability of mounting the electronic component 10 loses.

Next, a first method of manufacturing the electronic component 10 according to the first embodiment will be explained with reference to FIG. 5.

First, a plating bath 15 filled up with a Sn—Bi solution 14 containing the tin (Sn) and the bismuth (Bi) is prepared. The Sn—Bi solution 14 includes organic acid, mineral acid, surfactant, sali-Sn, sali-Ni, and a like. Then, a positive plate 16 made of the Sn—Ni alloy containing 0.01 weight % to 3 weight % of the nickel (Ni), preferably approximately 3 weight % of the nickel (Ni) is placed (immersed) in the Sn—Bi solution 14 anda electronic component 10A as an object to be plated is also placed (immersed) in the Sn—Bi solution 14, and the positive plate 16 and the electronic component 10A as an object to be plated are respectively connected to a positive electrode 17A and a negative electrode 17B of a direct current source 17. The content of nickel (Ni) in the Sn—Ni alloy in the positive plate 16 is set to approximately 3 weight % which the nickel (Ni) is supplied enough to an alloy to be plated. However, when the content of nickel (Ni) is set to approximately 0.01 weight % or more, the nickel (Ni) canbe supplied without problems. The content of nickel (Ni) changes dependently on the presence or absence of a chelate component, a kind of a chelate component, or a like.

As a result, electrolysis of the Sn—Bi solution 14 occurs, the tin (Sn) and the bismuth (Bi) in the Sn—Bi solution 14 ionize to Sn ions (+) and Bi ions (+) respectively. And, following reaction occurs respectively in the positive plate 16 and the electronic component 10A as an object to be plated. First, in the positive plate 16, both of the tin (Sn) and the nickel (Ni) to be structure components of the Sn—Ni alloy become Sn ions (+) and Ni ions (+) while electrons (−) remain, and dissolve in the Sn—Bi solution 14 in which the Sn ions (+) and the Bi ions (+) exist as described above. Then, in the electronic component 10A as an object to be plated, all of the Sn ion (+), the Bi ions (+) and Ni ions (+) in the Sn—Bi solution 14 move to the lead 2 connected to the negative electrode 17B and are combined with electrons (−) supplied from the negative electrode 17B, and thus, the Sn—Bi alloy containing the nickel (Ni) is plated on the lead 2 as the connection conductive layer 3. Here, as to the connection conductive layer 3 to be plated on the lead 2, a composition of the Sn—Bi solution 14 and a composition of the positive plate 16 are controlled in a manner that a 0.05 weight % to 1.5 weight % of the nickel (Ni) is contained in the Sn—Bi alloy. With this operation, the electronic component 10 shown in FIG. 1 and FIG. 2 can be manufactured.

In addition to that, the ionization tendency of the nickel (Ni) is close to that of the tin (Sn) being a main component of the Sn—Bi alloy, and the ionization tendency of the nickel (Ni) is greater than that of the tin (Sn). Therefore, the nickel (Ni) is previously contained in the positive plate 16 as the Sn—Ni alloy, whereby an enough amount of the nickel (Ni) can dissolve in the Sn—Bi solution 14. Also, by depositing the bismuth (Bi) on the positive plate 16, it can be reduced that the bismuth (Bi) is deposited on the lead 2 of an electronic component. This can be carried out by using the Sn—Ni alloy previously containing approximately 3 weight % being a suitable amount of the nickel (Ni) as the positive plate 16 without using a special material. Therefore, the nickel (Ni) is electroplated on the lead 2 of the electronic component 10 together with the tin (Sn) and the bismuth (Bi), whereby the connection conductive layer 3 having the low melting point and containing a 0.05 weight % to 1.5 weight % of the nickel (Ni) in the Sn—Bi alloy can be formed. Additionally, since the nickel deposition hardly occurs, by adding the chelate agent if necessary, a specified content of nickel (Ni) can be obtained.

Next, a second method of manufacturing the electronic component 10 according to the first embodiment will be explained with reference to FIG. 6. A main difference between the first method and the second method is that the second method is configured to add the nickel (Ni) in a solution in the second method, whereas the positive plate does not contain the nickel (Ni).

That is, in the second method, a plating bath 19 filled up with a Sn—Bi—Ni solution 18 containing the nickel (Ni) in addition to the tin (Sn) and the bismuth (Bi) is prepared. A positive plate 20 made of the tin (Sn) is placed in the Sn—Bi—Ni solution 18 and an electronic component 10A having the lead 2 (not shown) to be plated is also placed (immersed) in the Sn—Bi—Ni solution 18, and the positive plate 20 and the electronic component 10A as an object to be plated are respectively connected to a positive electrode 17A and a negative electrode 17B of a direct current source 17. An additional amount of the nickel (Ni) for the Sn—Bi—Ni solution 18 is set in a manner that the nickel (Ni) is supplied enough to a Sn—Bi alloy to be plated while plating as follows.

As a result, electrolysis of the Sn—Bi—Ni solution 18 occurs, the tin (Sn), the bismuth (Bi) and the nickel (Ni) in the Sn—Bi—Ni solution 18 ionize to Sn ions (+), Bi ions (+) and Ni ions (+) respectively. And, following actions occur in the positive plate 20 and the electronic component 10A as the object to be plated. First, in the positive plate 20, the tin (Sn) leaves electrons (−), becomes a Sn ion (+) in a state where an electron remain (−) and the Sn ion (+) dissolves in the Sn—Bi—Ni solution 18 containing the Sn ion (+), the Bi ion (+) and the Ni ion (+) Then, in the electronic component 10A as the object to be plated, all of the Sn ion (+), the Bi ion (+) and Ni ion (+) in the Sn—Bi—Ni solution 18 are drawn to the lead 2 connected to the negative electrode 17B and are combined with electrons (−) supplied from the negative electrode 17B, and then, the Sn—Bi alloy containing the nickel (Ni) is plated on the lead 2 as the connection conductive layer 3. Here, as to the connection conductive layer 3 to be plated on the lead 2, a composition of the Sn—Bi—Ni solution 18 is controlled in a manner that a 0.05 weight % to 1.5 weight % of the nickel (Ni) is included in the Sn—Bi alloy. When the additional amount of the nickel (Ni) in the Sn—Bi—Ni solution 18 is insufficient and the content of nickel (Ni) in the connection conductive layer 3 is out of the above-described range, the nickel (Ni) is newly added in the Sn—Bi—Ni solution 18 from an outside. With this operation, the electronic component 10 shown in FIG. 1 and FIG. 2 can be manufactured.

According to the second manufacturing method, by previously adding a suitable amount of the nickel (Ni) to the Sn—Bi—Ni solution 18, only the positive plate 20 made of a single metal is used, whereby the nickel (Ni) is electroplated to the lead 2 of the electronic component 10 together with the tin (Sn) and the bismuth (Bi) and it is possible to form the connection conductive layer 3 having the low melting point and containing a 0.05 weight % to 1.5 weight % of the nickel (Ni) in the Sn—Bi alloy.

As described above, in the electronic component 10 according to the first embodiment, since the connection conductive layer 3 made of the Sn—Bi alloy containing a 0.05 weight % to 1.5 weight % of the nickel (Ni) is formed on a surface of the lead 2 as the external terminal, the nickel (Ni) is hardly solid-soluble in the tin (Sn) and is crystallized as the nickel deposition phase 13, and the component atoms making up the Sn—Bi alloy is inhibited from migrating along the crystal grain boundary 12 between the Sn crystals 11.

Also, in the first method of manufacturing the electronic component 10 according to the first embodiment, by electroplating the lead 2 using the positive plate 16 made of the Sn—Ni alloy containing the nickel (Ni), the connection conductive layer 3 made of the Sn—Bi alloy containing a 0.05 weight % to 1.5 weight % of the nickel (Ni) is formed on the lead 2, and therefore, the connection conductive layer 3 can be formed easily.

Also, in the second method of manufacturing the electronic component 10 according to the first embodiment, by electroplating the lead 2 using the Sn—Bi—Ni solution, the connection conductive layer 3 made of the Sn—Bi alloy containing a 0.05 weight % to 1.5 weight % ofthe nickel (Ni) is formed on the lead 2, and therefore, the connection conductive layer 3 can be formed easily.

Therefore, it is possible to make the time passage change of the alloy structure of the Sn—Bi alloy used as the connection conductive layer small.

Second Embodiment

A main difference between an electronic component of the first embodiment and that of the second embodiment is that zinc (Zn), aluminum (Al) or iron (Fe) is included in the Sn—Bi alloy as a metal of which an ionization tendency is greater than that of the tin (Sn).

The electronic component 10 of the second embodiment as shown in FIG. 1 and FIG. 2 is provided with a connection conductive layer 3 containing the zinc (Zn), aluminum (Al) or iron (Fe) instead of the nickel (Ni) in the Sn—Bi alloy formed on a surface of a lead 2. Zinc (Zn), aluminum (Al) or iron (Fe) is selected as a metal of which a solid solubility limit to the tin (Sn) at room temperature is less than that of Bi and of which an ionization tendency is greater than that of the tin (Sn) almost similarly to the above-described nickel (Ni). Since the solid solubility limit of the Sn—Bi alloy containing zinc (Zn), aluminum (Al) or iron (Fe) to the tin (Sn) is small, a deposition phase crystallizes similarly to the Sn—Bi alloy containing nickel (Ni), and therefore, the alloy structure of the Sn—Bi alloy can be made stable. To manufacture the electronic component, the connection conductive layer 3 is formed according to a first manufacturing method or a second manufacturing method previously described.

As described above, the second embodiment can obtain approximate same effects as the first embodiment.

Third Embodiment

A main difference between an electronic component of the first embodiment and that of a third embodiment is that, in the third embodiment, copper (Cu), silver (Ag), palladium (Pd), or gold (Au) is included in the Sn—Bi alloy as a metal of which an ionization tendency is less than that of the tin (Sn).

The electronic component 10 according to the third embodiment is provided with a connection conductive layer 3 containing copper (Cu), silver (Ag), palladium (Pd), or gold (Au) instead of nickel (Ni) in the Sn—Bi alloy formed on a surface of a lead 2 shown in FIG. 1 and FIG. 2. Copper (Cu), silver (Ag), palladium (Pd), or gold (Au) is selected as a metal of which a solid solubility limit to the tin (Sn) at room temperature is less than that of bismuth (Bi) and of which an ionization tendency is less than that of tin (Sn) similarly to the above-described nickel (Ni). Since the solid solubility limit of the Sn—Bi alloy containing copper (Cu), silver (Ag), palladium (Pd), or gold (Au) to tin (Sn) is small, a deposition phase crystallizes similarly to the Sn—Bi alloy containing the nickel (Ni), and therefore, the alloy structure of the Sn—Bi alloy can be made stable.

Additionally, in the third embodiment, since copper (Cu), silver (Ag), palladium (Pd), or gold (Au) deposits not only on the lead 2 (negative electrode) of the electronic component but also on a positive plate, a consumption speed of each metal becomes fast, and therefore, it is desirable to use a method in which each metal is previously added to a solution like a second manufacturing method according to the first embodiment.

As described above, the third embodiment can obtain approximate same effects as the first embodiment.

It is apparent that the present invention is not limited to the above embodiments but may be changed and modified without departing from the scope and spirit of the invention.

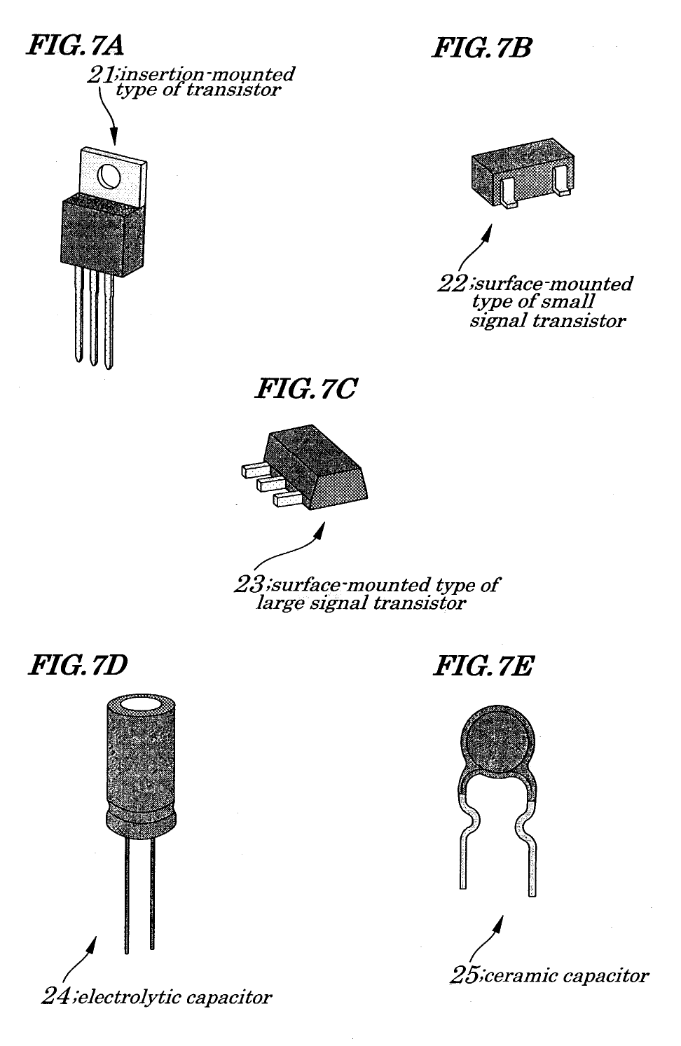

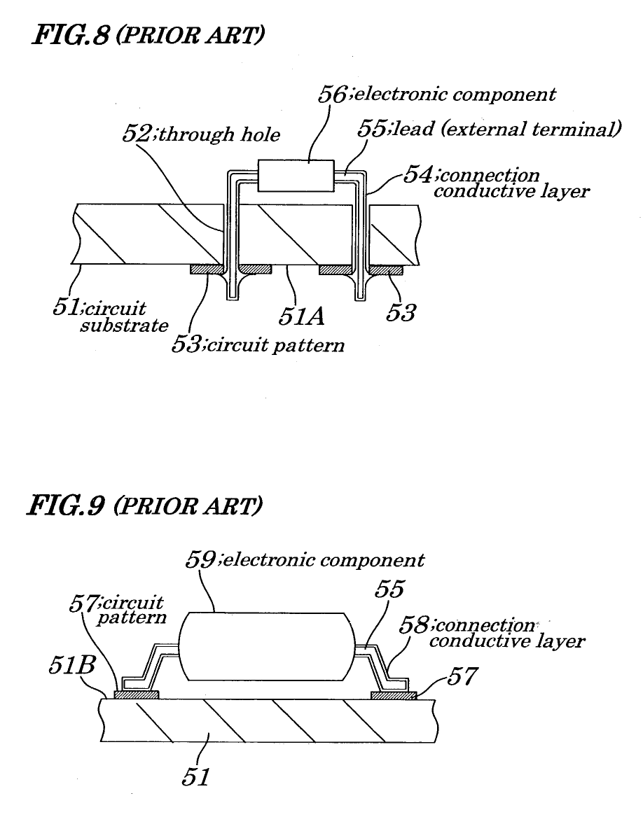

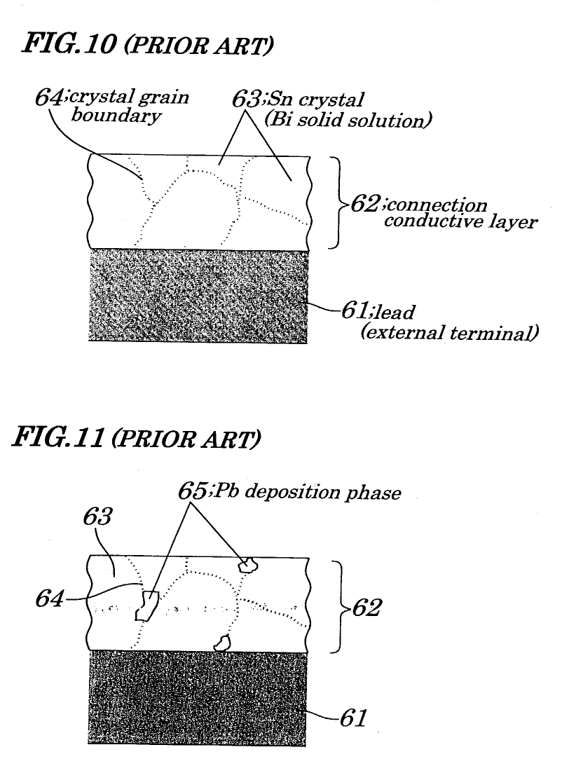

For example, in the above-described embodiments, the connection conductive layer 3 is formed on the lead 2, however, it is also applicable to a ball-shaped electrode used as an external terminal not limited to the lead 2. Also, in the above-described embodiments, a semiconductor device such as an IC or a like is used as the electronic component, however, the present invention is applicable to an insertion-mounted type of transistor 21 shown in FIG. 7A, a surface-mounted type of small signal transistor 22 shown in FIG. 7B, a surface-mounted of large signal transistor 23 shown in FIG. 7C, an electrolytic capacitor 24 shown in FIG. 7D, a ceramic capacitor 25 shown in FIG. 7E, and various kinds of other electronic components.

Also, in the electronic component in which nickel (Ni) is included in the Sn—Bi alloy according to the first embodiment, when a conductive material such as the Fe—Ni alloy containing nickel (Ni) is used as the lead 2 of an electronic component, by applying a reverse electrolysis to the lead 2 temporally, the nickel (Ni) can be dissolved in the solution so as to be supplied into the solution. Also, when a connection conductive layer 3 containing a desired metal is formed on the Sn—Bi alloy shown in each embodiment, after adhering the desired metal onto a surface of the lead 2 by a physical technique such as a sputter technique, a heat treatment may be applied in a manner that the metal is diffused. According to this technique, particularly, when a connection conductive layer 3 containing a plurality of metals is formed, a heat treatment is applied only once after adhering the plurality of metals, and therefore, the connection conductive layer 3 can be formed easily.

What is claimed is:

1. An electronic component having an external terminal of which a surface is covered with a connection conductive layer made of a tin-bismuth alloy, wherein said tin-bismuth alloy contains a metal of which a solid solubility limit to tin at room temperature is less than that of bismuth in said tin-bismuth alloy.

2. The electronic component according to claim 1, wherein said metal of which said solid solubility limit to said tin at said room temperature is less than that of bismuth and is a metal of which an ionization tendency is greater than that of said tin.

3. The electronic component according to claim 2, wherein said metal of which said ionization tendency is greater than that of said tin is nickel, and a 0.05 weight percent to 1.5 weight percent of said nickel is included in said tin-bismuth alloy.

4. The electronic component according to claim 2, wherein said metal of which said ionization tendency is greater than that of said tin is zinc, aluminum, or iron.

5. The electronic component according to claim 1, wherein said metal of which said solid solubility limit to said tin is less than that of said bismuth and is a metal of which an ionization tendency is less than that of said tin.

6. The electronic component according to claim 5, wherein said metal of which said ionization tendency is less than that of said tin is copper, silver, palladium, or gold.

7. The electronic component according to claim 1, wherein said connection conductive layer is formed by an electroplating method.

8. The electronic component according to claim 1, comprising a semiconductor device.

9. A method of manufacturing an electronic component having an external terminal of which a surface is covered with a connection conductive layer made of a tin-bismuth alloy, said method comprising:
a step of placing a positive plate and said external terminal respectively in a solution containing tin and bismuth, said positive plate being made of a tin-nickel alloy containing 0.01 weight percent to 3 weight percent of nickel and being connected to a positive electrode of a direct current source, and also said external terminal being connected to a negative electrode of said direct current source; and
a step of forming said connection conductive layer made of said nickel-bismuth alloy containing a 0.05 weight percent to 1.5 weight percent of nickel on said external terminal by an electroplating method.

10. A method of manufacturing an electronic component having an external terminal of which a surface is covered with a connection conductive layer made of a tin-bismuth alloy, said method comprising:
a step of placing a positive plate and said external terminal respectively in a solution containing tin, bismuth and nickel, said positive plate being made of tin and being connected to a positive electrode of a direct current source, and also said external terminal being connected to a negative electrode of said direct current source; and
a step of forming said connection conductive layer made of said nickel-bismuth alloy containing a 0.05 weight percent to 1.5 weight percent of nickel on said external terminal by an electroplating method.

11. A method of manufacturing an electronic component having an external terminal of which a surface is covered with a connection conductive layer made of a tin-bismuth alloy, said method comprising:
a step of applying a heat treatment so as to diffuse a specified metal after coating tin, bismuth and said specified metal to said external terminal; and
a step of forming said connection conductive layer made of said tin-bismuth alloy containing a specified amount of said specified metal on said external terminal.
